(19) United States
(12) Patent Application Publication
(10) Pub. No.: US 2021/0094492 A1
(43) Pub. Date: Apr. 1, 2021

(54) MULTI-MODAL KEYLESS MULTI-SEAT IN-CAR PERSONALIZATION

(71) Applicant: Cerence Operating Company, Burlington, MA (US)

(72) Inventors: Hendrik Zender, St. Wendel (DE); Patrick Langer, Neu-Ulm (DE); Daniel Mario Kindermann, Aachen (DE)

(21) Appl. No.: 17/036,390

(22) Filed: Sep. 29, 2020

Related U.S. Application Data
(60) Provisional application No. 62/908,068, filed on Sep. 30, 2019.

(51) Int. Cl. B60R 16/037; B60N 2/00; G06F 21/32; H04S 7/00; G06K 9/00

(52) U.S. Cl. CPC B60R 16/037; B60N 2/002; G06K 9/00288; H04S 7/303; G06K 9/00838; G06F 21/32

(57) ABSTRACT

In-car personalization methods/systems for applying personalized settings to car functionality and for allowing multiple passengers in a car to apply personalized settings to their individual location in the care and according to stored preferences. The methods/systems provide multi-user profile selections using one or more of: (1) key-less multi-user profile selection; (2) biometric multi-user profile selection; and/or a combination of multi-modal technologies for {key-less, biometric} multi-user profile selection. The disclosed methods/systems combine multiple available sensors to solve the complementary tasks of: (1) detecting the presence of a person, (2) performing a coarse classification of the occupants (e.g., driver vs passenger; child vs adolescent/adult), (3) seat-based localization of detected occupants, and (4) identification of a specific user.

### CROSS-REFERENCES TO RELATED APPLICATIONS

This application claims the benefit of U.S. Provisional Application No. 62/908,068 filed Sep. 30, 2019, the contents of which are incorporated by reference herein.

### BACKGROUND

This invention relates to in-car personalization systems that apply personalized settings to car functionality. More particularly, the present disclosure relates to such in-car personalization systems that allow multiple passengers in a car to apply personalized settings to their individual location in the car according to stored preferences.

Known in-car personalization systems available in the market utilize individualized keys to identify the driver and apply personalized settings for the driver to car functionality such as adjusting the driver seat, adjusting the exterior mirrors, adjusting AC temperature settings, personalizing navigation settings, selecting the preferred driving profile, and configuring other settings such as those of driver assistance systems, radio stations and other infotainment devices.

Recently, there have been other approaches to in-car personalization that rely on identifying the driver through means other than individualized keys, such as by voice biometrics. As alternative options, such known systems (key-enabled or speech-enabled) typically also allow to different drivers to log in or change the user (and thus the in-car personalized settings) via the head-unit display.

However, these existing systems do not allow for the application of individualized personalization settings (such as seat adjustments, AC zone settings, infotainment preferences) for the other passengers in the car because only one user can be logged in at any time, and that user is the driver.

### SUMMARY

The benefits of not relying on a specific key to identify a driver/passenger become apparent in situations where not every driver/passenger has their own dedicated key or brings their own key. For example, the benefits can be envisioned in situations such as switching drivers on longer journeys or riding in a rental car or other shared car, to name just a few. Moreover, relying on a car key is not a useful criterion for identifying non-driver vehicle occupants.

The benefits of not relying on a specific key to identify a driver/passenger also extend beyond the traditional automotive end user market, e.g., the one owner and main driver of a car with a small number of infrequent drivers, or typical family cars. The disclosed methods/systems make the features useful in shared mobility applications, such as company carpools and fleets, rent-a-car companies, and car sharing businesses.

The above benefits of not relying on a specific key to identify a driver/passenger derive from the ability to provide multi-user profile selections using one or more of: (1) key-less multi-user profile selection; (2) biometric multi-user profile selection; and/or (3) a combination of multi-modal technologies for (key-less, biometric) multi-user profile selection.

The disclosed methods/systems combine multiple available sensors to solve the complementary tasks of: (1) detecting the presence of a car occupant, (2) performing a coarse classification of the occupants (e.g., driver vs. passenger; child vs. adolescent/adult), (3) seat-based localization of the detected occupants, and (4) identification of a specific occupant.

In one embodiment, these tasks can be performed in any order, can be performed sequentially or consecutively, or can be performed in any combination thereof.

The disclosed methods/systems rely on combinations of existing technology/sensors in novel ways. For example, the disclosed methods/systems rely on the presence of several different sensors that most cars are equipped with in order to perform the above tasks, and employ a “dual-use” (or “plurality-use”) of these existing sensors for multi-user personalization. Examples of such sensors with a given primary purpose are, e.g., seat occupancy detectors typically used for seat belt warning, microphones typically used for hands-free phone calling, in-car cameras typically used for the driver monitoring systems. Using one or more of the available sensors, the disclosed methods/systems can be implemented in any car without requiring additional hardware. Of course, it is also possible to equip cars with sensors for the sole or primary purpose of the methods disclosed herein. The exact configuration of available sensors will vary between car models and will be apparent to those of skill in the art based on the present disclosure. The availability and quality of different sensors for any given instance of the disclosed methods/systems will determine the exact set of supported features and their accuracy/reliability.

In one embodiment, the disclosed methods/systems extend in-car personalization to provide enhanced and improved functionality.

In one embodiment, the disclosed methods/systems provide key-less identification of users.

In one embodiment, the disclosed methods/systems rely on biometric characteristics (i.e., measurable features of human individuals) for identifying users.

In one embodiment, the disclosed methods/systems utilize a plurality of in-car sensors for different types of user recognition.

In one embodiment, the disclosed methods/systems provide user identification ranging over several levels of granularity (i.e., from mere presence detection to unique identification).

In one embodiment, the disclosed methods/systems can be technically instantiated in many different configurations, depending on which sensors are available, e.g., by sharing sensors that a car is already equipped with for other purposes.

In one embodiment, the disclosed methods/systems use multi-modal sensor fusion to perform user recognition passively i.e., without necessarily requiring a specific action of the user to be identified (e.g., by inserting a hardware token, speaking a certain command, registering a finger print, or making a specific gesture, and the like).

In one embodiment, the disclosed methods/systems use a combination of multi-modal technologies for user identification to achieve a key-less user profile selection for multiple persons in a car, including driver and passengers, not just the driver as in existing approaches.

In one embodiment, the disclosed methods/systems provide user identification and the application of personalized settings utilizing a cloud component.

In one embodiment, the disclosed methods/systems match user profiles against an off-board (e.g., off-car cloud database) that allows any user to be recognized when in any car, not just by their own personal car.

The disclosed methods/systems will be described in more detail in conjunction with the accompanying drawings, which should not be considered as limiting the invention in any manner unless specifically so stated. In one aspect, the method features using available sensors in a vehicle to perform certain steps. These sensors are generally those that are already being used in the vehicle to serve other functions. The invention thus includes using these sensors for an additional task, namely that of detecting the presence of an occupant in the vehicle, classifying the occupant, localizing the seat-based location of the occupant, and identifying the occupant.

Among the practices are those in which identifying the occupant includes identifying the occupant in reliance on at least one biometric characteristic and those in which identifying the occupant includes matching a profile of the occupant against an off-board database.

A variety of ways are available for classifying the occupant. Among the practices of the method are those in which classifying the occupant includes determining whether the occupant is a driver or a passenger and those in which classifying the occupant includes determining whether the occupant is an adult or other than an adult, for example, a child, infant, or adolescent. Also, among the practices are those in which classifying includes classifying the occupant into one of a plurality of roles. Examples of such roles include the roles of driver and passenger. In such embodiments, each of the roles has a corresponding attribute. Examples of such attributes include settings, permissions, and preferences.

Other practices include applying certain settings based on either having identified the occupant or having classified the occupant. Among these are practices in which the settings that are to be applied are settings that have been retrieved from the cloud. Also, among these practices are those in which applying certain settings includes applying preferences, settings, or parameters associated with the occupant and those that include applying preferences, settings, or parameters associated with the class into which the occupant has been classified.

In some practices, the available sensors include a microphone set that has one or more microphones. In such cases, practices of the invention include those that use the microphone set to detect the occupant's speech and to identify a location from which the occupant's speech originated, thus carrying out the step of localizing the occupant's seat-based location. Also among the practices of the method are those that use the microphone set to obtain a signal characterizing the user's speech so that retrieved voice biometric data can be used to identify the occupant based at least in part on the voice biometric data.

In other practices, the available sensors include a camera set that includes one or more cameras. In such cases, practices of the method include using the camera set to acquire an image of the occupant or to acquire images of seats. In the former case, the method also includes retrieving facial-recognition data and identifying the occupant based at least in part on the facial-recognition data. In the latter case, the method continues with using the images of the seats to determine which seat is occupied by the occupant.

In other practices, the available sensors include a radio sensor configured to detect a communication signal from a handheld personal device. In such cases, the practices of the method further include detecting a signal from a personal device and identifying the occupant based at least in part on the communication signal.

In other practices, the available sensors include a seat-occupancy detector. When such sensors are available, practices of the method include those in which classifying the occupant is based at least in part on data provided by the seat-occupancy detector and those in which localizing the occupant's seat-based location includes localizing it based at least in part on data provided by the seat-occupancy detector.

Practices also include those in which identifying the occupant includes identifying a specific occupant and those in which identifying the occupant includes determining that the occupant is a member of a set that is smaller than the set into which the occupant has been classified.

The steps of the method need not be carried out in any particular order. For example, in some practices, classifying the occupant includes classifying the occupant after having localized the seat-based location of the occupant. In others, detecting the presence of the occupant and localizing the seat-based location of the occupant occur concurrently. And in still other practices, identifying the occupant occurs before localizing the seat-based location of the occupant.

In one aspect, the method features using available sensors in a vehicle to perform certain steps. These sensors are generally those that are already being used in the vehicle to serve other functions. The invention thus includes using these sensors for an additional task, namely that of detecting the presence of an occupant in the vehicle, classifying the occupant, localizing the seat-based location of the occupant, and identifying the occupant.

Among the practices are those in which identifying the occupant includes identifying the occupant in reliance on at least one biometric characteristic and those in which identifying the occupant includes matching a profile of the occupant against an off-board database.

A variety of ways are available for classifying the occupant. Among the practices of the method are those in which classifying the occupant includes determining whether the occupant is a driver or a passenger and those in which classifying the occupant includes determining whether the occupant is an adult or other than an adult, for example, a child, infant, or adolescent. Also among the practices are those in which classifying includes classifying the occupant into one of a plurality of roles. Examples of such roles include the roles of driver and passenger. In such embodiments, each of the roles has a corresponding attribute. Examples of such attributes include settings, permissions, and preferences.

Other practices include applying certain settings based on either having identified the occupant or having classified the occupant. Among these are practices in which the settings that are to be applied are settings that have been retrieved from the cloud. Also among these practices are those in which applying certain settings includes applying preferences, settings, or parameters associated with the occupant and those that include applying preferences, settings, or parameters associated with the class into which the occupant has been classified.

In some practices, the available sensors include a microphone set that has one or more microphones. In such cases, practices of the invention include those that use the microphone set to detect the occupant's speech and to identify a location from which the occupant's speech originated, thus carrying out the step of localizing the occupant's seat-based location. Also among the practices of the method are those that use the microphone set to obtain a signal characterizing the user's speech so that retrieved voice biometric data can be used to identify the occupant based at least in part on the voice biometric data.

In other practices, the available sensors include a camera set that includes one or more cameras. In such cases, practices of the method include using the camera set to acquire an image of the occupant or to acquire images of seats. In the former case, the method also includes retrieving facial-recognition data and identifying the occupant based at least in part on the facial-recognition data. In the latter case, the method continues with using the images of the seats to determine which seat is occupied by the occupant.

In other practices, the available sensors include a radio sensor configured to detect a communication signal from a handheld personal device. In such cases, the practices of the method further include detecting a signal from a personal device and identifying the occupant based at least in part on the communication signal.

In other practices, the available sensors include a seat-occupancy detector. When such sensors are available, practices of the method include those in which classifying the occupant is based at least in part on data provided by the seat-occupancy detector and those in which localizing the occupant's seat-based location includes localizing it based at least in part on data provided by the seat-occupancy detector.

Practices also include those in which identifying the occupant includes identifying a specific occupant and those in which identifying the occupant includes determining that the occupant is a member of a set that is smaller than the set into which the occupant has been classified.

The steps of the method need not be carried out in any particular order. For example, in some practices, classifying the occupant includes classifying the occupant after having localized the seat-based location of the occupant. In others, detecting the presence of the occupant and localizing the seat-based location of the occupant occur concurrently. And in still other practices, identifying the occupant occurs before localizing the seat-based location of the occupant.

Other features and advantages of the invention are apparent from the following description, and from the claims.

### DESCRIPTION OF DRAWINGS

The accompanying drawings illustrate aspects of the present disclosure, and together with the general description given above and the detailed description given below, explain the principles of the present disclosure. As shown throughout the drawings, like reference numerals designate like or corresponding parts.

FIG. 1 shows a matrix of sensors and tasks explaining the techniques for which the sensors can be used to perform the indicated tasks, and with which restrictions or pre-requisites, according to the present disclosure.

FIG. 2 shows a table that illustrates typical applications of user preferences and permissions, and how these can be applied based on role or user identity, according to the present disclosure.

FIG. 3 shows a flow chart of one possible sequence of steps for user detection, location, identification and application of personal settings, according to the present disclosure.

FIG. 4 shows a flow chart of an alternative possible sequence of steps for user detection, location, identification and application of personal settings, according to the present disclosure.

### DETAILED DESCRIPTION

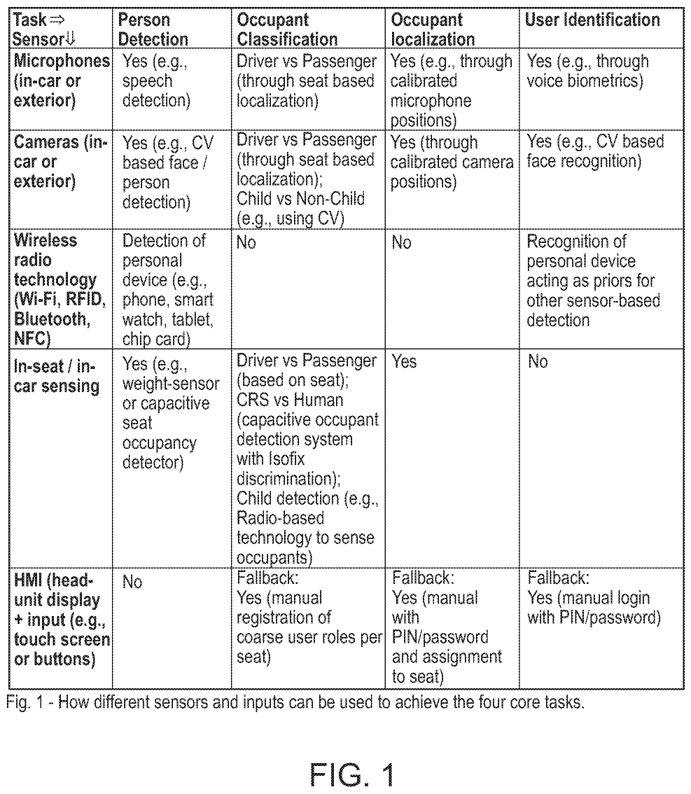

FIG. 1 shows how different sensors can be used to achieve the four (4) core tasks set forth above: (1) detecting the presence of a car occupant, (2) performing a coarse classification of the occupants (e.g., driver vs passenger; child vs adolescent/adult), (3) seat-based localization of the detected occupants, and (4) identification of a specific occupant. Fallback task performance objectives using manual login/registration are also presented. For example, under the task of “Person Detection”, microphones via, e.g., speech detection, cameras via, e.g., face/person detection, wireless radio technology via, e.g., detection of personal wireless devices, and/or in-seat sensing via, e.g., weight sensing can be used to perform this task. On the other hand, HMI (a head unit display and input) cannot perform the task of “Person Detection”. The other three (3) core task and which sensors can perform these tasks are similarly set forth in FIG. 1 using the same methodology.

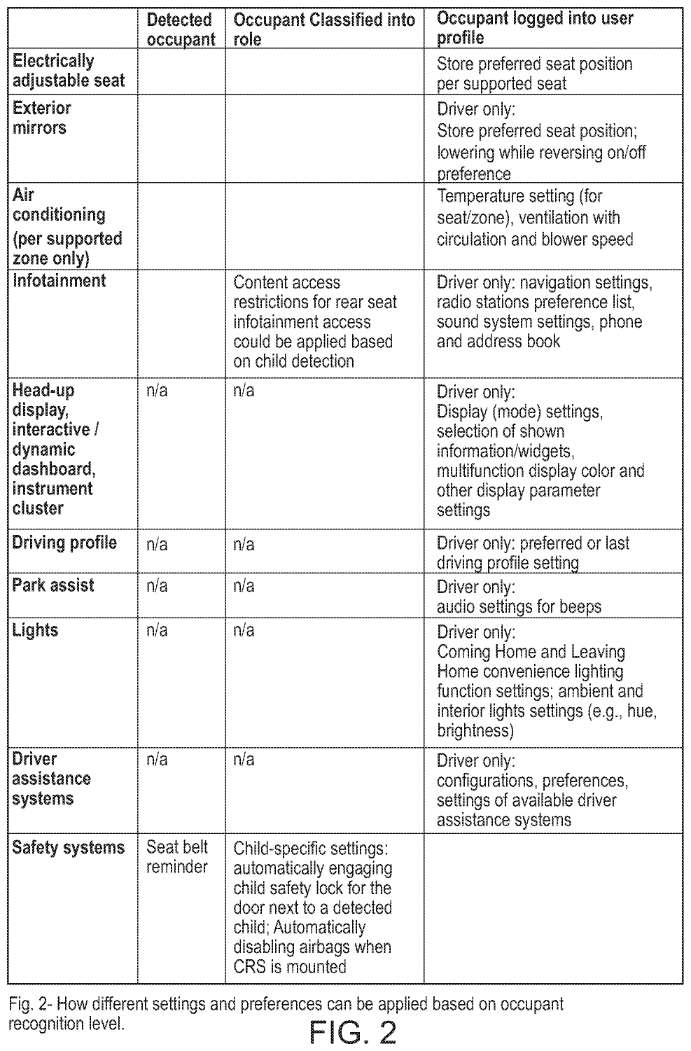

FIG. 2 shows how different settings can be applied based on the granularity of the occupant recognition level. As seen in FIG. 2, some settings and preferences can be applied solely to the driver position/identification, while others can be applied to the driver position/identification and other passenger position/identification. For example, electrically adjustable seat positions and air conditioning settings can be applied to both the driver and other occupants, while exterior mirror settings can be applied solely to the driver. Also, by way of example, infotainment settings can be applied so that different levels of “access” can be applied, such as content restrictions based on child recognition. As is also shown in FIG. 2, more settings and preferences can be applied if the occupant (driver or non-driver) is logged into a user profile. Thus, setting a user profile is paramount to allow the full panoply of benefits of the present disclosure to be enjoyed.

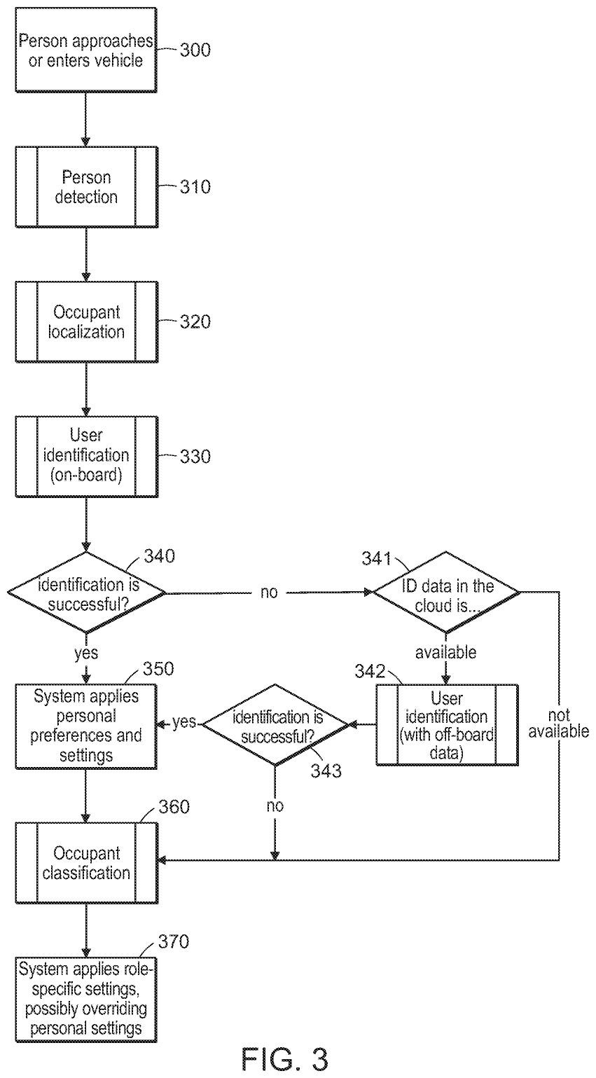

FIG. 3 shows one possible sequence of steps for user detection, location, identification and application of personal settings, according to the present disclosure. As noted above, these steps can be performed sequentially or consecutively or a combination thereof, or some steps can be omitted, or others added. In step 300, a person approaches or enters a vehicle. In step 310, person detection is performed, such as by any of the techniques set forth in the first column of FIG. 1. In step 320, occupant localization is performed, such as by any of the techniques set forth in the third column of FIG. 1. In step 330, user identification is performed “on-board” the vehicle, such as by any of the techniques set forth in the fourth column of FIG. 1. In step 340, a decision point is reached, and the question is asked: “Is identification successful?”. If the answer to that question is “Yes”, the process proceeds to step 350, where the system applies stored personalized preferences and settings, that can be, in one embodiment, retrieved from stored preferences and settings in the cloud. In step 360, occupant classification is performed, such as by any of the techniques set forth in column two of FIG. 1. In step 370, role-specific settings are applied based, in part, on occupant classification from step 360, and these role-specific settings may override personal settings applied in step 350. Returning to step 340, if the answer to the question: “Is identification successful?” is “No” the process proceeds to step 341. In step 341, another decision point is reached, and the question is asked: “Is identification data available on the cloud?”. If the answer to that question is “Yes”, the process proceeds to step 342, and user identification is attempted using “off-board” (e.g., cloud) data. In step 343, another decision point is reached, and the question is asked: “Is identification successful?”. If the answer to that question is “Yes” the process proceeds to step 350, and if the answer to that question is “No”, the process proceeds to step 360. Returning to In step 341, if the answer to the question: “Is identification data available on the cloud?” is “No”, the process proceeds to step 360.

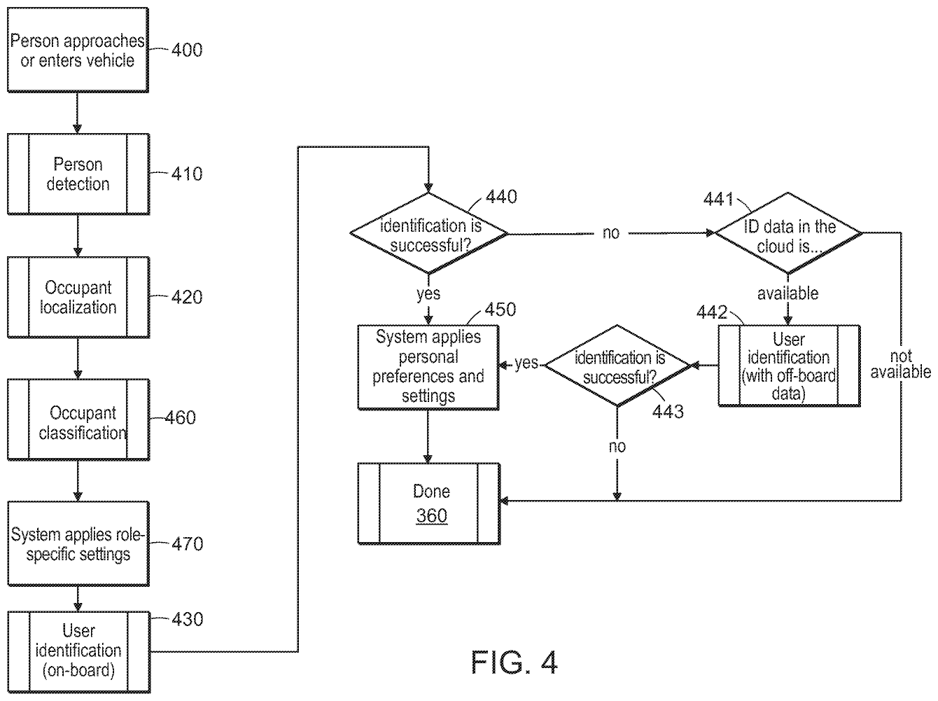

FIG. 4 shows another possible sequence of steps for user detection, location, identification, and application of personal settings, according to the present disclosure. In this sequence, a person approaches or enters a vehicle (step 400). In step 410, person detection is performed, such as by any of the techniques set forth in the first column of FIG. 1. In step 420, occupant localization is performed, such as by any of the techniques set forth in the third column of FIG. 1. In step 430, occupant classification is performed, such as by any of the techniques set forth in column two of FIG. 1. In step 440, role-specific settings are applied, based at least in part, on occupant classification from step 430.

In step 450, the system attempts to identify the user using data that it has available. Such data is referred to herein as “on-board data.” The system attempts to carry out this on-board identification using any of the techniques set forth in the fourth column of FIG. 1. The system then determines whether the attempt at on-board identification succeeded (step 460). If so, the system proceeds to apply stored personalized preferences and settings (step 470). In some embodiments, the system retrieves such preferences and settings from the cloud, where they have been stored. The stored personalized preferences and settings may override role settings applied in step 440.

Returning to step 450, if identification is unsuccessful, the system attempts to locate off-board identification data in the cloud (step 451). If such identification data is found, the system attempts to identify the occupant using this off-board data (step 442). The system then determines whether this attempt at off-board identification was successful (step 453). It the attempt was successful, the system proceeds to apply stored personalized preferences and settings (step 470). In some embodiments, the system retrieves such preferences and settings from the cloud, where they have been stored. The stored personalized preferences and settings may override role settings applied in step 440. After having applied these personal preferences and settings, the system brings the procedure to a close (step 360). If the off-board identification was not successful, the system retains all the applied role-specific settings from step 440 and also brings the procedure to a close (step 360).

At the core of the personalization approach disclosed herein are preferences, settings and parameters that are stored and applied (see, e.g., FIG. 2). A collection of such settings and parameters is referred to herein as a “profile”. There is a distinction between coarse profiles that are based on occupant roles, and user specific profiles that are linked to a user account. Coarse profiles are applicable for occupants that are not logged in (and potentially unknown to the system), while user specific profiles require the user to have a user account and to be logged into that account.

A one-time activity of user enrollment for creating a user account will now be described. There are three types of personal data to discuss for the creation of a user profile and complete implementation of the methods/systems of the present disclosure.

Data Type 1-Identification Data- Data type 1 consists of user name and-for purposes of the full benefit of the present disclosure-authentication data, e.g. face profile, voiceprint, identification of a specific mobile device; with a PIN or password as fallback.

Data Type 2-General User Preferences and Information Related to Automotive Use-Data Type 2 includes, for example: (1) addresses and/or phone numbers for home, work, and other relevant places and people; (2) login information for 3^{rd} party accounts (e.g., messaging services, music streaming services, social network services); (3) navigation preferences (e.g., map orientation, whether to mute guidance prompts by default; and/or (4) infotainment preferences (e.g., favorite radio stations). Obviously, other personal preferences can be included here.

Data Type 3-Car-Specific Settings-Data Type 3 includes, for example: e.g., seat adjustment parameters, mirror adjustment parameters.

Data Type 1 is mandatory for user enrollment. User enrollment may take place either within the car utilizing e.g., the car's HMI, cameras, microphones and sensors or outside the car, e.g., via a smartphone or PC. Data Type 2 can be collected and edited in any of these environments. Data Type 3 is tied to a particular car model and therefore only can be collected in the car, unless functions can be created that allow for modeling seat and window positions based on another car's settings, or unless cameras and sensors can be used to automatically adjust seat and window positions whenever a user enters a car unknown to him.

Once a user is enrolled, the task then is to identify the user and to identify the seat the user is occupying when they enter any particular car. Once both the user and seat are identified, the user might be automatically logged in at their seat (this might be a preferable option for privately owned or frequently used cars), or the system might offer users the ability to log in, for example in an un-intrusive way, e.g., via a login button on a screen within in reach of the user. Alternatively, a mobile device owned by the user can be utilized to offer the user the ability to log in.

In order to address shared mobility and mobility-as-a-service markets, such as car sharing, car rental, or car-pooling, the relevant user enrollment and profile data need to be accessible in different cars. To this end, the present disclosure provides that such data is stored in a central cloud network data storage, and a user login can be performed remotely. An alternative solution, the present disclosure provides that such data (user enrollment and profile data) can be stored, accessed and transferred through a personal device, e.g., using a companion smart phone app.

For user identification, the methods/system can provide that the car could continuously monitor the interior for users entering, e.g., by help of cameras (face detection), microphones (voice biometry), or other means (e.g., RFID) (see, also FIG. 1). The methods/systems can also be enabled to recognize known users in the nearby environment outside a stationary car by e.g., continuous scanning, which can allow for e.g., automatically adjusting the appropriate seat for the recognized user when a door is being opened by that user, i.e., before the user sits down, and/or e.g., for faster loading of personal data from the cloud.

The disclosed methods/systems also encompass methods for classifying occupants who are not enrolled into the coarse categories. This allows pre-setting certain preferences and parameters without requiring user login. For instance, certain child-related safety settings can be applied automatically (see, e.g., FIG. 2).

Also, in accordance with the present disclosure, preferences, settings and permissions can be structured around “roles”. Some roles can be assigned to occupants that are classified into any of the coarse categorizations afforded by the specific sensor configuration, e.g., driver vs. non-driver; child vs. non-child. Expanded roles can be created and managed as additional user roles if more fine-grained customization per user is desired. As an example, user roles and permissions in the context of a consumer car solution can implement more or fewer roles and can thus scale to emerging roles in (semi-)autonomous driving, as well as to taxi ride or even robotic taxi ride applications. By way of example, the following roles can be considered: driver, passenger and child. Besides the personalized user preference settings, occupants might have or might not have certain permissions, such as infotainment access, or access to other car settings depending on the assigned role. Such permission restrictions depend on the occupant's role(s) and seating location, and, potentially, their specific user identity. Management of user roles can be performed using the HMI (display and available input) or any other means that affords user enrollment. The present disclosure provides the ability, if desired, to distinguish between default permissions that can be managed by role, and individual permissions by user that can selectively override the defaults.

Abbreviations used herein include:

AC: Air Conditioning

CRS: Child Restraint System, child car seat

CV: Computer Vision

NFC: Near-Field Communication

RFID: Radio-Frequency Identification

SSE: Speech Signal Enhancement

As used herein, the terms “a” and “an” mean “one or more” unless specifically indicated otherwise.

As used herein, the term “substantially” means the complete or nearly complete extent or degree of an action, characteristic, property, state, structure, item, or result. For example, an object that is “substantially” enclosed means that the object is either completely enclosed or nearly completely enclosed. The exact allowable degree of deviation from absolute completeness can in some cases depend on the specific context. However, generally, the nearness of completion will have the same overall result as if absolute and total completion were obtained.

As used herein, the term “about” is used to provide flexibility to a numerical range endpoint by providing that a given value can be “a little above” or “a little below” the endpoint. Further, where a numerical range is provided, the range is intended to include any and all numbers within the numerical range, including the end points of the range.

While the present disclosure has been described with reference to one or more exemplary embodiments, it will be understood by those skilled in the art, that various changes can be made, and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure will not be limited to the particular embodiments disclosed herein, but that the disclosure will include all aspects falling within the scope of the appended claims and a fair reading of present disclosure.

It is to be understood that the foregoing description is intended to illustrate and not to limit the scope of the invention, which is defined by the scope of the appended claims. Other embodiments are within the scope of the following claims.

What is claimed is:

1. A method comprising, using available sensors in a vehicle, performing the steps of detecting the presence of an occupant in the vehicle, classifying the occupant, localizing the seat-based location of the occupant, and identifying the occupant.

2. The method of claim 1, wherein identifying the occupant comprises identifying the occupant in reliance on at least one biometric characteristic.

3. The method of claim 1, further comprising applying personalized settings based on having identified the occupant, the personalized settings being retrieved from the cloud.

4. The method of claim 1, wherein identifying the occupant comprises matching a profile of the occupant against an off-board database.

5. The method of claim 1, wherein classifying the occupant comprises determining whether the occupant is a driver or a passenger.

6. The method of claim 1, wherein classifying the occupant comprises determining whether the occupant is an adult or other than an adult.

7. The method of claim 1, wherein the available sensors include a microphone set that comprises one or more microphones and localizing the seat-based location of the occupant comprises using the microphone set to detect the occupant's speech and to identify a location from which the occupant's speech originated.

8. The method of claim 1, wherein the available sensors include a microphone set that comprises one or more microphones and wherein identifying the occupant comprises using the microphone set to obtain a signal representative of the occupant's speech, the method further including retrieving voice biometric data and identifying the occupant based at least in part on the voice biometric data.

9. The method of claim 1, wherein the available sensors include a camera set that comprises one or more cameras and identifying the occupant comprises using the camera set to acquire an image of the occupant, the method further comprising retrieving facial-recognition data and identifying the occupant based at least in part on the facial-recognition data.

10. The method of claim 1, wherein the available sensors include a camera set that comprises one or more cameras and localizing the seat-based location of the occupant comprises using the camera set to acquire images of seats, the method further comprising using the images to determine which seat is occupied by the occupant.

11. The method of claim 1, wherein the available sensors comprise a radio sensor configured to detect a communication signal from a handheld personal device, the method further comprising detecting a personal device, wherein identifying the occupant comprises identifying the occupant based at least in part on the communication signal.

12. The method of claim 1, wherein the available sensors comprise a seat-occupancy detector and wherein classifying the occupant comprises classifying the occupant based at least in part on data provided the seat-occupancy detector.

13. The method of claim 1, wherein the available sensors comprise a seat-occupancy detector and wherein localizing the seat-based location of the occupant comprises localizing the seat-based location based at least in part on data provided by the seat-occupancy detector.

14. The method of claim 1, wherein identifying the occupant comprises identifying a specific occupant.

15. The method of claim 1, wherein identifying the occupant occurs before localizing the seat-based location of the occupant.

16. The method of claim 1, wherein classifying the occupant comprises classifying the occupant after having localized the seat-based location of the occupant.

17. The method of claim 1, wherein detecting the presence of the occupant and localizing the seat-based location of the occupant occur concurrently.

18. The method of claim 1, wherein classifying comprises classifying the occupant into one of a plurality of roles, each of said roles having a corresponding attribute selected from the group consisting of settings, preferences, and permissions.

19. The method of claim 1, further comprising applying preferences, settings, or parameters associated with the occupant.

20. The method of claim 1, further comprising applying preferences, settings, or parameters associated with the class into which the occupant has been classified.
